(19) United States
(12) Patent Application Publication
(10) Pub. No.: US 2011/0237358 A1
(43) Pub. Date: Sep. 29, 2011

(54) System, method and device for selecting a golf club

(76) Inventor: Danny Carpenter, Fort Morgan, CO (US)

(21) Appl. No.: 12/661,798

(22) Filed: Mar. 23, 2010

(51) Int. Cl. A63B 57/00; G06F 19/00

(52) U.S. Cl. 473/407; 700/91

(57) ABSTRACT

A system and device for selecting a golf club comprises a data entry means, an adjustment means, and a tag production means. A usage method is also disclosed. A golfer enters his or her individual data into the system via a computing device having software that accepts information about a golfer's shot distances, clubs, etc. The computing device manipulates and adjusts the data and creates customized shot distance chart information based on half, three-quarters and full swings of various golf clubs. A club selection card is produced which is inserted into a tag having a clear sleeve for viewing the card and a connection means to secure it to a golf bag. A usage method can comprise a golfer being presented with a particular shot situation; the golfer references the tag and selects an appropriate club from the information on the tag in order to make the shot.

### TECHNICAL FIELD

This invention relates generally to the field of golf and in particular to a system, method and device for selecting a golf club.

### BACKGROUND

The sport of golf has a long and storied history. The exact origins of the game are unclear. However, a widely accepted theory is that this sport originated in Scotland in the middle ages. Historical accounts reference somewhat similar games in both China and the Netherlands, but the roots of the well-known game of today, as played over eighteen holes, is generally traced to Scotland. Regardless of its origins, the sport of golf has developed into a widely played game, with many new players taking up the challenge every day.

Especially for new players, the process of selecting the appropriate club to be used for a given shot can be an extremely demanding task. There are many devices currently known in the art that can assist in club selection. For example, U.S. Pat. No. 6,030,297 to Kliewer discloses a golf club range indicator system that displays the closest distance and furthest distance that a particular player can hit a golf ball with each of his or her clubs. Although this system is helpful, it has a number of failings. As the ranges of distances are inset into pins or end-caps that attach to the end of each club handle, a new player has to spend an inordinate amount of time rummaging through his or her selection of clubs trying to decide which club provides an appropriate range for each shot.

In order to address some of these difficulties, electronic devices such as that disclosed by U.S. Patent Application Publication No. 2002/0177494 A1 to Kersten have been developed. Such electronic devices limit the amount of time spent rummaging through a bag of clubs, but still provide only limited information to the golfer. For example, Kersten does not teach or disclose any method or device for allowing a golfer to choose a club based on the distance a ball will travel when a particular club is hit using a half-swing instead of the golfer's full swing.

For experienced players, who are playing on an open course with wide fairways, clear sight-paths and golf ball travel lanes are usually encountered. However, a single sub-optimal swing can land a ball out of the fairway where trees and other obstacles can immediately become an issue. This is especially true for beginner golfers who often find themselves off the fairway and in situations where a golf ball must be hit around, over, under or through obstacles.

When obstacles such as trees, sand traps, man-made structures, etc. are introduced into a given shot, it can be particularly difficult to determine how best to utilize various clubs and half, three-quarters, and full swings to avoid obstacles. For example, a golfer may normally use a nine iron to hit a ball about 110 yards. However, nine irons generally loft the ball a considerable distance vertically as well as driving it horizontally and if a tree blocks the ball's travel lane vertically, a club with a shorter loft must be used. If a five iron is selected in order to avoid the overhanging tree, the golfer must not utilize a full swing or he or she risks over-driving the ball, since a normal distance for his or her five iron might be 150 yards. Neither the Kersten nor the Kliewer systems above assist with this situation. Other golf club selection systems and devices known in the art also fail to adequately address the situation.

Clearly, then, there is a need for a golf system, method and device for providing a golfer with a quick reference chart of customized information providing distances that the particular golfer can drive a golf ball utilizing a half swing, three-quarters swing, and full swing with each of his or her clubs. The present invention accomplishes these objectives.

### SUMMARY

Embodiments of the present invention described and claimed herein address the foregoing limitations and problems by providing a system, method and device for selecting a golf club based on half, three-quarters, and full swings.

In one embodiment, a system, method and device for selecting a golf club comprises a data entry means, an adjustment means, a tag production means and a usage means. Methods for utilizing each of the means are contemplated, resulting in a system for selecting a golf club.

The present invention provides many benefits over the prior art. The system, method and device for selecting a golf club can be customized for each golfer such that distances used in the calculations are specific to a particular golfer. For example, while a weaker golfer may hit a golf ball 120 yards with a three-quarters swing of his three iron, a stronger golfer may hit the same ball 170 yards with a three-quarters swing of his three iron. Such variations need to be taken into account in order for a golf club selection system to be significantly helpful for a particular golfer. Furthermore, the information provided to the golfer is available as a chart on a tag that can be hung from the golf bag so that the golfer can quickly and easily scan the tag for a particular range and determine which club would provide the best shot-solution for a given situation. Unlike devices currently known in the art, a golfer is not provided with only a full swing distance when a three-quarters swing situation is called for, necessitating that the golfer estimate a reduction in the shot distance. Instead, a golfer is provided with half, three-quarters and full swing shot distances for each club he or she chooses to carry.

### BRIEF DESCRIPTION OF THE DRAWINGS

The aforementioned and other features and objects of the present invention and the manner of attaining them will become more apparent and the invention itself will be best understood by reference to the following descriptions of a preferred embodiment and other embodiments taken in conjunction with the accompanying drawings, wherein:

FIG. 1 illustrates a perspective view of an exemplary embodiment of a system for selecting a golf club having a data entry means, an adjustment means, and a tag production means;

FIG. 2 illustrates a close-up, perspective view of an exemplary embodiment of a device for selecting a golf club, showing a club selection card in a golf bag tag;

FIG. 3 illustrates an exemplary embodiment of a method for using a device for selecting a golf club; and

FIG. 4 illustrates a perspective view of an exemplary embodiment of a system for selecting a golf club having a data entry means, an adjustment means, a tag production means and a usage method.

### DETAILED DESCRIPTION

In one embodiment, a system for selecting a golf club comprises a data entry means, an adjustment means, and a tag production means. A usage method is also disclosed. The data entry means can comprise a golfer entering his or her individual data into a computing device having software that accepts information about a golfer's shot distances, clubs, etc. An adjustment means can comprise the computing device utilizing the software to manipulate the data and create customized shot distance chart information based on half, three-quarters and full swings of each club desired by the golfer. A tag production means can comprise printing a club selection card which is then inserted into a tag having a clear sleeve for viewing the inserted card and a loop or other connection means for securing the tag to a golf bag. A usage method can comprise a golfer being presented with a particular shot situation while out on the golf course, the golfer then quickly referencing the tag and selecting the appropriate club from the information on the tag in order to then make the shot.

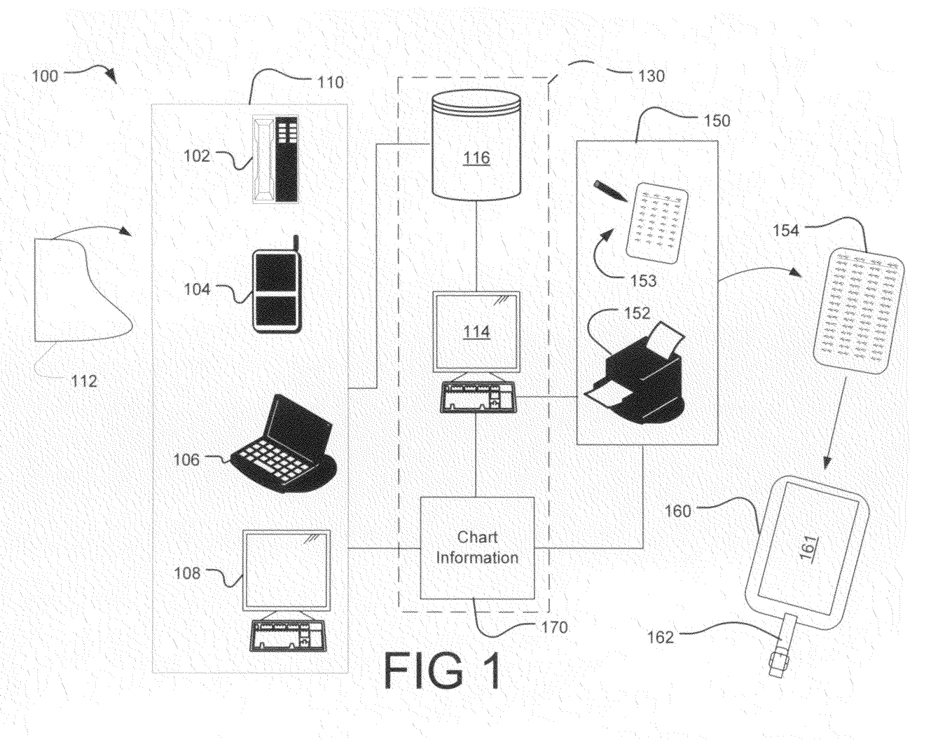

FIG. 1 illustrates a perspective view of an exemplary embodiment of a system for selecting a golf club 100 having a data entry means 110, an adjustment means 130 and a tag production means 150. The data entry means 110 can comprise a golfer entering his or her individual data 112 into an electronic device having software that accepts information about a golfer's shot distances, clubs, etc. In one embodiment, the data entry means 110 is a telephone 102. In another embodiment, the data entry means 110 is a mobile device such as a cell phone 104. In yet another embodiment, the data entry means 110 is laptop or other computer 106 connected to a remote website. Alternatively, the data entry means 110 can comprise a local computing device 108. In any case, once the data 112 is entered via the data entry means 110, it is stored in a repository 116 that can comprise a database or any other data storage means known in the art.

An adjustment means 130 can comprise a separate computing device 114 utilizing software to manipulate the data 112 entered by the data entry means 110. The data 112 can be stored in a repository 116 and the computing device 114 can create the chart information 170. As discussed above, different golfers will often have different shot distances for a given club. Many of those differences are relatively consistent across a range of clubs. Therefore, given some initial information concerning a golfer, any of a number of calculation systems currently known in the art can be used to extrapolate approximate shot distance information for a particular golfer. The adjustment means 130 can utilize such calculations broadly, or it can allow the golfer to manually modify each shot distance entry to match his or her own actual numbers, or it can use a combination of both. In another embodiment, the data entry means 110 can also be a component of the adjustment means: the data entry means 110 can utilize software to manipulate the data 112 stored in the repository 116 and create customized shot distance chart information 170 based on half, three-quarters and full swings of each club desired by the golfer.

A tag production means 150 can comprise transferring the chart information 170 to a printing device 152 and printing a club selection card 154. In another embodiment, the tag production means 150 can comprise copying the chart information 170 manually 153 onto a club selection card 154. Other tag production means 150 are contemplated. The card 154 can then be inserted into a tag 160 having a clear sleeve 161 for viewing the inserted card 154 and a loop or other connection means 162 for securing the tag 160 to a golf bag. The connection means 162 can include a buckle, snap, hook and loop, or any other suitable means for connecting the tag 160 to a golf bag. In another embodiment, the clear sleeve 161 is tinted or otherwise not totally clear.

The tag 160 can be made of leather, vinyl, rigid fabric, or any other suitable material(s). The card 154 can be made of vinyl, plastic, or any other suitably rigid, water-resistant material. The back of the tag 160 could have a clear sleeve as well or it could be opaque or translucent. The back could display a logo, golf tips, key swing thoughts, etc.

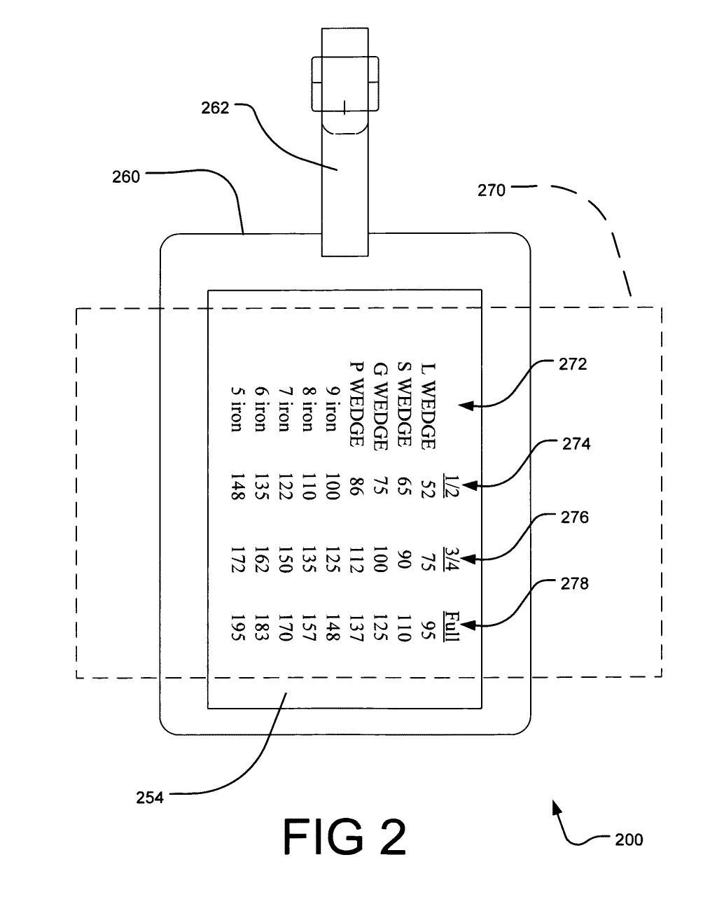

FIG. 2 illustrates a close-up, perspective view of an exemplary embodiment of a device for selecting a golf club 200, showing a club selection card 254 in a golf bag tag 260. The club selection card 254 displays the chart information 270 which embodies the shot distance information calculated in the system. In the embodiment shown in FIG. 2, sample chart information data 270 is displayed; many other possible data values and configurations are contemplated. Also shown in FIG. 2 is a buckle-type connection means 262.

The chart information 270 contains at least four groupings of data: club type data 272, half swing distance data 274, three-quarters swing distance data 276, and full swing distance data 278. In other embodiments, the data is arranged in other ways. Additional data and information can be displayed without departing from the scope of the invention. Furthermore, a golfer may choose to limit the chart information 270 to a custom grouping of clubs used by that particular golfer.

The club type data 272 comprises labels for the various clubs that a golfer generally carries. The displayed clubs can be selected from a list of all possible clubs, for example, an “S Wedge” is a sand wedge, a “P Wedge” refers to a pitching wedge, etc. The club type data 272 can include more than one label referring to a single type of club; for example, “9 iron O” could refer to a golfer's favorite old 9 iron, while “9 iron N” could refer to a golfer's new and improved 9 iron.

The half swing distance data 274 comprises data concerning how far a golfer hits a golf ball by using a half swing for each club. In the exemplary data shown in FIG. 2, common distances for an average male golfer of average height and build are listed. The half swing distance data 274 can be customized for each individual golfer.

The three-quarters swing distance data 276 comprises data concerning how far a golfer hits a golf ball by using a three-quarters swing for each club. In the exemplary data shown in FIG. 2, common distances for an average male golfer of average height and build are listed. The three-quarters swing distance data 276 can be customized for each individual golfer.

The full swing distance data 278 comprises data concerning how far a golfer hits a golf ball by using a full swing for each club. In the exemplary data shown in FIG. 2, common distances for an average male golfer of average height and build are listed. The full swing distance data 278 can be customized for each individual golfer.

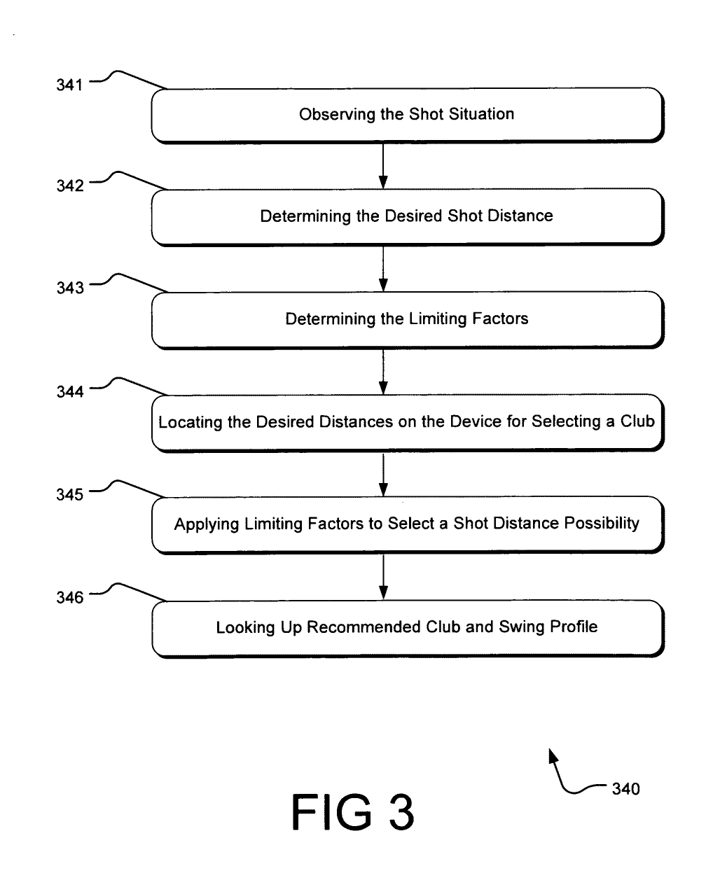

FIG. 3 illustrates an exemplary embodiment of a method for using a device for selecting a golf club 340. The method 340 comprises the following steps: observing the shot situation 341, determining the desired shot distance 342, determining the limiting factors 343, locating the desired shot distance possibilities on the device for selecting a golf club 344, applying the limiting factors to select a single shot distance possibility 345, and looking up the recommended club and swing profile to make the shot 346.

In the observing the shot situation step 341, a golfer examines the lie of the golf ball, the location of the pin, the sight-path and anticipated golf ball travel lane, the wind, location(s) of obstacle(s), topography and obstacles of the projected ball landing area, etc. All of these factors are important considerations for determining how best to hit the ball. For example, if the wind is blowing quite strongly, the golfer will likely use a lower-lofting club in order to keep the golf ball from rising too high and being blown of course by the wind.

The golfer determines the desired shot distance 342 through any method currently known or yet to be employed in the art, such as: employing a laser rangefinder, approximating based on range pins set up on the fairway, using straight approximation, employing global positioning system range finding, etc.

The determining limiting factors step 343 involves the golfer reviewing the shot situation as found in the observing the shot situation step 341 with an eye towards highlighting the factors that will weigh towards using a half or three-quarters swing instead of a full swing. Such factors include: ball loft limitations, e.g., wind, tree branches, etc.; ball roll limitations, e.g., a water hazard immediately beyond the ball landing target area would necessitate precise shot placement instead of allowing a ball to bounce and roll forward after landing; room to swing full club lengths, e.g., if the backswing would impact an obstacle, a shorter club and/or swing limitation might need to be employed; etc.

In the locating the desired shot distance possibilities on the device for selecting a golf club step 344, the golfer simply examines the chart information 270 and finds the listings of desired shot distance possibilities. As three-quarters and half swings of smaller numbered clubs will generally drive golf balls similar distances to full swings of higher numbered clubs, a range of desired shot distance possibilities will be found on the chart information 270. The golfer then needs to perform the applying the limiting factors to select a single shot distance possibility step 345. This is accomplished by taking into account the limiting factors from the determining limiting factors step 343 and deciding which club of those recommended would be fulfill the demands of the shot situation.

Finally, the golfer uses the chart information 270 to look up the recommended club and swing profile to make the shot step 346. The result is a club recommendation that the golfer can then use to select an appropriate club.

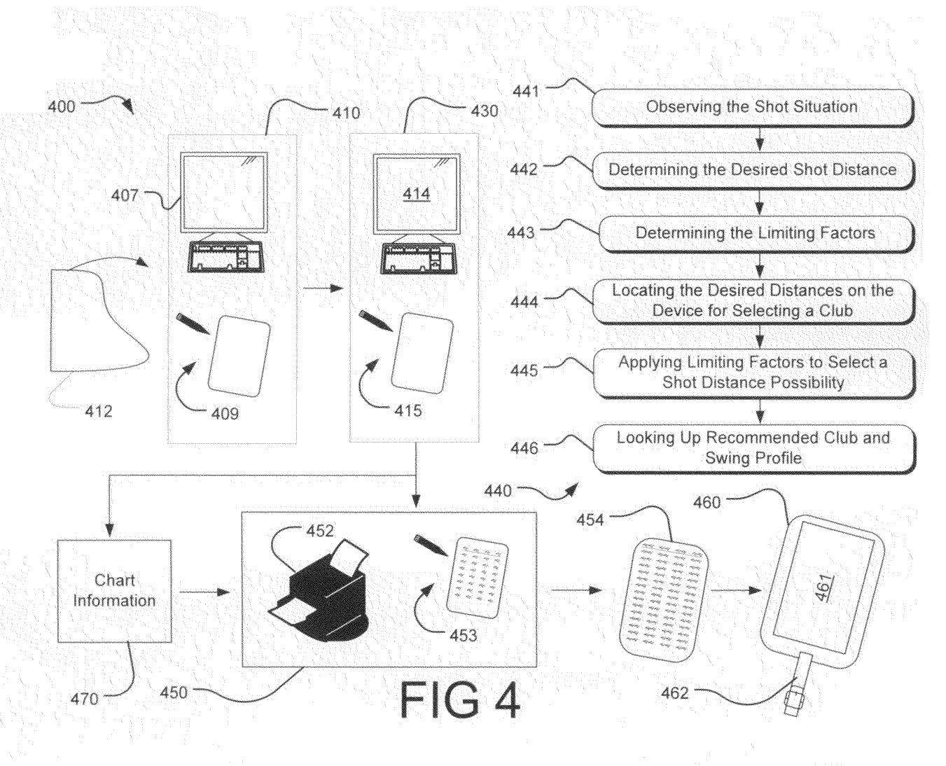

FIG. 4 illustrates a perspective view of an exemplary embodiment of a system for selecting a golf club 400 having a data entry means 410, an adjustment means 430, a tag production means 450 and a usage method 480.

The data entry means 410 can comprise a golfer entering his or her individual data 412 into a remote website 407 having software that accepts information about a golfer's shot distances, clubs, etc. In another embodiment, the data entry means 410 can comprise a golfer entering information on a hard-copy worksheet 409.

An adjustment means 430 can comprise the website server 414 utilizing software to manipulate the data 412 and creating customized shot distance chart information 470 based on half, three-quarters and full swings of each club desired by the golfer. In another embodiment, a golfer uses a hard-copy worksheet 415 and the worksheet instructs the golfer on how to manually adjust the data 412 and create the chart information 4170, and this comprises the adjustment means 430.

In one embodiment, a tag production means 450 can comprise the golfer instructing the website server 414 to print a club selection card 454. The website server 414 then transfers the chart information 470 to a printing device 452 and prints a club selection card 454. In another embodiment, the website 414 simply displays the chart information 470 so that the golfer can copy it manually onto a card 454.

The card 454 can be inserted into a tag 460 having a clear sleeve 461 for viewing the inserted card and a loop 462 or other connection means for securing the tag 460 to a golf bag 469. In other embodiments, other tag production means 450 are contemplated.

In one embodiment, a usage method 440 involves the golfer observing the shot situation 441, determining the desired shot distance 442, determining the limiting factors 443, locating the desired shot distance possibilities on the device for selecting a club 444, applying the limiting factors to select a single shot distance possibility 445, and looking up the recommended club and swing profile on the device for selecting a club to make the shot 446.

The above specification, examples and data provide a description of the structure and use of exemplary embodiments of the described articles of manufacture and methods. Many embodiments can be made without departing from the spirit and scope of the invention.

What is claimed is:

1. A system for selecting a golf club, comprising:
a means for entering data about a golfer and at least one distance the golfer can hit a golf ball with at least one golf club;
a means for adjusting the data to customize it for the golfer and produce a chart information containing golf ball hitting distances for at least half swing, three-quarters swing, and full swing of the at least one golf club;
a means for producing a tag, wherein the tag can be attached to a golf bag and the tag displays the chart information; and
wherein the golfer can use the chart information to select an appropriate club to use for a given shot situation.

2. The system for selecting a golf club of claim 1, wherein the means for entering data comprises an electronic device having software that accepts information about the golfer and the at least one distance the golfer can hit a golf ball with the at least one golf club.

3. The system for selecting a golf club of claim 1, wherein the means for adjusting the data comprises a computing device utilizing software to manipulate the data and create the chart information.

4. The system for selecting a golf club of claim 2, wherein the means for adjusting the data comprises a computing device utilizing software to manipulate the data and create the chart information.

5. The system for selecting a golf club of claim 1, wherein the means for producing a tag comprises a printing device that receives the chart information and creates a club selection card that fits into and is displayed by the tag.

6. The system for selecting a golf club of claim 2, wherein the means for producing a tag comprises a printing device that receives the chart information and creates a club selection card that fits into and is displayed by the tag.

7. The system for selecting a golf club of claim 3, wherein the means for producing a tag comprises a printing device that receives the chart information and creates a club selection card that fits into and is displayed by the tag.

8. The system for selecting a golf club of claim 4, wherein the means for producing a tag comprises a printing device that receives the chart information and creates a club selection card that fits into and is displayed by the tag.

9. A method of selecting a golf club, comprising:
observing a shot situation;
determining a desired shot distance;
determining limiting factors;
locating desired shot distance possibilities on a device for selecting a golf club;
applying the limiting factors to select a single shot distance possibility from the device;
looking up a recommended club and swing profile on the device; and
selecting an appropriate golf club.

10. The method of selecting a golf club of claim 9, wherein the observing the shot situation step comprises a golfer examining at least one of a lie of the golf ball, a location of a pin, a sight-path and anticipated golf ball travel lane, a wind, a location of an obstacle, or a topography of a projected ball landing area.

11. The method of selecting a golf club of claim 10, wherein the determining limiting factors step comprises the golfer reviewing the shot situation as found in the observing the shot situation step with an eye towards highlighting any factors that will weigh towards using a half or three-quarters swing instead of a full swing of a golf club.

12. The method of selecting a golf club of claim 11, wherein the locating the desired shot distance possibilities on the device for selecting a golf club step comprises the golfer examining a chart information on the device and finding listings of desired shot distance possibilities.

13. The method of selecting a golf club of claim 12, wherein the applying the limiting factors to select a single shot distance possibility step comprises the golfer taking into account the limiting factors and deciding which club of those recommended by the device would fulfill a demand of the shot situation.

14. A device for selecting a golf club, comprising:
a club selection card that displays chart information, wherein the chart information contains at least four groupings of data including club type data, half swing distance data, three-quarters swing distance data, and full swing distance data; and
a golf bag tag displaying the club selection card and having a connection means for attaching the tag to a golf bag.

15. The device for selecting a golf club of claim 14, wherein the club type data comprises labels for various clubs that a golfer generally carries.

16. The device for selecting a golf club of claim 15, wherein the half swing distance data comprises data concerning how far a golfer hits a golf ball by using a half swing for each club.

17. The device for selecting a golf club of claim 16, wherein the three-quarters swing distance data comprises data concerning how far a golfer hits a golf ball by using a three-quarters swing for each club.

18. The device for selecting a golf club of claim 17, wherein the full swing distance data comprises data concerning how far a golfer hits a golf ball by using a full swing for each club.
